(19) United States
(12) Patent Application Publication
(10) Pub. No.: US 2021/0296838 A1
(43) Pub. Date: Sep. 23, 2021

(54) DUAL CRIMPER & CUTTER HAND TOOL, DIE WHEEL AND JAW THEREFOR AND METHOD OF USE THEREOF

(71) Applicant: Harger, Inc., Grayslake, IL (US)

(72) Inventor: Mark Harger, Kenosha, WI (US)

(73) Assignee: Harger, Inc., Grayslake, IL (US)

(21) Appl. No.: 16/824,089

(22) Filed: Mar. 19, 2020

(51) Int. Cl. H01R 43/042

(52) U.S. Cl. CPC H01R 43/0421

(57) ABSTRACT

The present disclosure relates to a new improved dual crimping and cutting tool, such as a portable hand tool with removable for repair or adding features having a rotating jaw serving in one area as a cutter blade against the body of the tool, and in an adjacent area a crimping portion for conducting a semi-circular crimping for one of multiple size conductors. The invention includes features such as a multi-die removable wheel, a rounded periphery multi-die removable wheel, a dual segment jaw, a multiple angle crimping nest, a new jaw with a self-release and a manual release, a high leveraged multi-groove driving pawl, and a removable blade system.

### FIELD OF TECHNOLOGY

The present disclosure relates to a new improved dual crimper and cutter hand tool having a unique die wheel and jaw and a method of use thereof. The tool and components are specifically adapted for work with large conductors for use in different fields, such as, for example, lightning protection systems where large-size conductors made of relatively ductile soft metal must be cut and crimped in a way which preserves both mechanical and conductance of a crimped conductor.

### BACKGROUND

At the turn of the 21^{st} Century, technical emphasis shifted from heavy and mechanical inventions to a novel space of micro-technology, cell technology, software and the internet. While these new technologies improved living standards, it is important to keep in mind the critical importance of new technology linked with infrastructure, electrical protection or other mechanical/electrical work. The current invention is in the area of tools which adds to efficiency of the work of electricians and other agents. The current invention is used to maintain, build, and update large and smaller size infrastructure, buildings, vehicles, and other large man-made systems as part of the toolbox of any qualified electrician and mechanical agent.

Electric systems, designed to move electricity often are made of conductors, like copper or metal wires connecting different places. Electricians and mechanical service agents often will be tasked with the installation, the maintenance, the removal and/or the repair of these networks of heavy and costly conductors. Often, the equipment is old, heavy, hard to repair and even hidden in places difficult to reach. Working in remote locations require compact and versatile light portable tools that must be useful in the right circumstance. Understandably, these electrical systems cannot be moved to a repair shop and repair and maintenance equipment must be brought to the point of use.

Users need the lightest and most versatile equipment that can be handled by one hand and this equipment must be made to service the largest range of conductors possible. The diversification of what a single tool can do helps prevent the need for multiple hand tools in the toolbox, where each one is sized for a different size or type of conductors.

As the inventor remind the reader that tradeoffs in variability in function (e.g. a tool for many sizes of conductors) often will results in a weaker tool with moving parts, and a lack of performance (e.g. a tool with weaker structure for each of these sizes). For example, the well-known indestructible wrench for a single sized bolt has a rounded loop at one hand, a C-shaped at the other end. Wrenches for many size bolts tradeoff the sturdiness for flexibility in use. One of ordinary skill in the art knows the tradeoff between the reliability of a tool designed for a single sized element when compared with a tool able to adapt to multiple sizes but suffering of inherent mechanical weaknesses linked with moving and pivoting parts.

While the current technology is designed for use in any field of engineering where tools or hand tools are needed, example will be given in one field namely in the lightning/electricity discharge protection technology for which the inventor happens to also be an expert. In this field, the use of hand tools is particularly useful as places of work are often remote and conductors are often very large. Inherent to the field of lighting/shock protection is a need for a good control of both mechanical and conductive (electricity) interfaces between pieces to avoid creating weaknesses in the resistance network being worked on for the reason explained below.

Conductors/Wires

In the current invention, the technology generally relates to a tool used to cut and crimp metal conductors (e.g. wires). In this very broad field, most conductors are rounded, covered in some type of colored plastic/polymer insulator and these conductors are given standardized shapes, sizes, and colors. While one example is given simply for enablement purposes, the sizes linked with hand tools and the conductors or other pieces they service are disclosed. What is contemplated is any geometry of cable or size of conductor able to benefit from the below-described technology. For example, under the American Wire Gauge (AWG) cable conductor size chart, the industry has agreed to the following:

| AWG | Diameter | Area | Color |
|---|---|---|---|
| (Copper) | (inches) | (mm2) | Die |
| 0000 (4/0) | 0.46 | 107 | Purple |
| 000 (3/0) | 0.41 | 85 | Orange |
| 00 (2/0) | 0.36 | 67.4 | Black |
| 0 (1/0) | 0.32 | 53.5 | Pink |
| 1 | 0.29 | 42.4 | Green |
| 2 | 0.26 | 33.6 | Brown |
| 4 | 0.20 | 21.3 | Grey |
| 6 | 0.16 | 13.3 | Blue |
| 8 | 0.13 | 8.4 | Red |
| 10 | 0.10 | 5.2 | #10 |

In the above an AWG number is assigned to a copper-based conductor (AWG 10 to 0) which is linked with the diameter of the conductor and its surface. Copper is a natural conductor as it has great conductivity but also is naturally malleable (ductile) and can easily be manipulated even at larger cross sectional areas. In the above chart, flow of current areas vary from 5 mm² to 53 mm² and the invention will described and shown using the above ranges. But one of ordinary skill in the art understands that while this specific range is used as a first embodiment, the technology can be applied for smaller, wider, larger, or different shaped conductors. Also shown above is a color code often helpful to guide electricians who need to cut and crimp to the cable.

Crimping Technology

Most metals have two natural molecular zones, a first elastic area best understood by the movement of a metal spring pulled and which returns at rest when the force is stopped. When a greater force is applied, the elastic area is passed and the metal enters locally into a plastic/ductile zone where force will permanently deform the metal. In this second zone, a spring would extend past a limit and when the force is removed, it would be permanently deformed. Paper clips are perfect ways to understand the distinction between these two zones where the clip works in the first zone as it holds paper, but is bent easily in the second zone to hold more pages.

Crimping is defined as the joining of two or more metal or other ductile material by ‘deforming one or more of them’ to hold the other. In essence, as part of crimping, sufficient force must be placed upon two materials so that either one or both enters the plastic/ductile area and the metals are bent to mimic the shape of the other metal creating a bond without the need of any third element such as glue. One advantage of deforming, the effective contact between two pieces will be increase and so with be the electrical conductive pathway between both pieces. If sufficient force is applied (i.e. passed a plastic deformation barrier), the metal of both crimped pieces will temporarily act malleably, like putty will form a bond and this will lower the effective resistance as the effective contact surface increases between both materials.

Crimping soft metals like copper is easier than crimping stronger like titanium. The inventor is particularly careful to take into consideration both a mechanical bond but also a conductive bond resulting from crimping. Bad crimping (i.e. with insufficient force or bad geometry) is dangerous in that while mechanically both pieces may appear to hold and seem secure when pulled apart, the contact area between both pieces may still include one or more gaps or air which adversely affect the conductive coefficient between both pieces.

Since this technology sits both on mechanical crimping and conductive crimping, it is important to remind the reader of the key notions linked with conductive issues linked with crimping. Inventor F. H. Wells, back in 1957 invented the famous Electrical Connection and Method where modern crimping was described using a stamping tool. In U.S. Pat. No. 2,795,769, as shown at FIG. 1 as prior art. This disclosure's first figure showed a cut conductor cable 51 stripped or not of the polymer surrounding shell. In this first step, a first tool is often needed to cut the conductor. The second figure from this patent shows a lug 52 in which the conductor is to be slid in and at the fourth figure shown below at FIG. 1, a vertical press pushes down 53 the rounded portion of the lug 52 which plastically deforms and crushes the tip of the conductor 51 forming a crimped bond. As shown, one of many types of lugs 52 is described. In this version, the lug 52 has an opening for securing the conductor to a second piece of conductor thus closing the electrical loop. As shown, sometime a conductor 51 is in fact a series/array of smaller conductor lines and as part of this disclosure, the term “conductor” covers any type of conductor including a multi-strain cable.

Over time, some hand tools have been created for crimping small single-sized conductors. FIG. 2 also from the prior art shows one illustration from U.S. Pat. No. 5,138,865 issued to inventor Tarpill. The document generally describes one crimping tool as illustrated. This crimper has at the center of a jaw a location 54 for the lug 52 and conductor 51 as assembled. To get plastic-level/ductile movement and level forces of compression (replacing the press shown at FIG. 1), the tool includes two handles 55, 56, located at the bottom of the figure which are used by a user to squeeze 55 and 56 together using a single hand. A great compression force is created in the jaws around the lug via a double effect of leverage. The same way a children's seesaw can lift a heavier child by placing him/her closer to a pivot point, the grip is designed to transform force F1 from the hand upon the handle 55 into larger force F2 multiplied by the ratio of the distance on each side of the pivot 56. As shown at FIG. 2, to the change F2 into a crushing vertical force F3, a second pivot 57 is used. The use of these force multipliers in these tools is critical in this art as ductile-level forces are needed locally.

As can be illustrated easily by the crimper at FIG. 2, these hand tools must be designed for force multiplication factors designed to “squeeze” a conductor as strongly as possible and as shown in a rounded configuration. Also important is the notion that while a crimp can be done on the tip of a cut conductor, a crimp can also be needed between two conductors or in a continuing conductor. The tool preferably must be designed with an opening allowing a continuing conductor to be slid into position. In this disclosure, while generally we describe a lug/conductor crimp as shown at FIG. 1, in the art multiple types and geometry of can be contemplated including for example between two rounded conductors twisted to each other.

Conductance in Conductor Networks

Crimping of conductors is generally linked securing two conductors mechanically to each other or securing a conductor to a structure via some type of lug. But very often conductors are used as part of an electrical network or electrically for grounding or shock protection. In most applications, a low level of electricity will flow in the conductor making the effective conductance of a crimped bond/linkage element secondary. As long as the bond holds mechanically, no problems will arise as the power will not be sufficient to heat or melt the conductor. But in some cases such as the industry of static discharge, lightning protection, there is a need for both enhancement of good crimped conductance and crimped mechanical resistance to avoid issues.

Metal is at a static level giving the body an overall electrical charge. In some instances, because of external conditions, the charge is superior than what is normally needed. In some instances, one object may receive additional electrons/energy while in other places in the same body the charge may be drawn down. Static energy is explained to children using the “balloon on hair” experiment. By simply rubbing the polymer on hair, static energy flow in these insulated elements. Some elements have a capacity to store and donate electrical charge without problem while others do not (e.g. void/vacuum). Elements without a strong capacity to store and donate electrons are said to “insulate” and serve as insulators.

Electrical conductivity at ground temperature a (Siemens per meter (S/m)) not to be confused with thermal conductivity (W/mK) values of some known materials include:

| Material | Conductance (S/m) | Relative % |
|---|---|---|
| Copper | 5.96 × 10⁷ | 100% |
| Stainless Steel | 1.45 × 10⁶ | 2.4% |
| Wood(damp) | 1 × 10⁻⁴ | Less than 0.001% |
| Glass | 1 × 10⁻¹¹ | Less than 0.001% |
| Rubber | 1 × 10⁻¹⁴ | Less than 0.001% |
| Air | 1 × 10⁻¹⁵ | Less than 0.0001% |

As shown above, an effective section of copper is highly conductive but when any portion of the conductive line is replaced with either steel or a surface made of air pocket and steel, the effective conductive value is dropped drastically to a fraction of what it should be. As shown at FIG. 1, the press 3 bent a simple circle down into the conductor in a heart shape. This created two pockets of air on both sides of the conductor in which the effective contact between both elements is greatly reduced and a portion is insulated.

Each year thousands of people are killed by natural electrostatic discharges between the atmosphere and the ground. Buildings, vehicles, and even individuals must be protected from a direct strike (at high power levels) or also protected from micro-discharges which can result in discomfort, sparks, electronic interference, etc. Minor static discharges can ignite gas leaks resulting in explosions in case of a failure of a gas line or can interfere with electronic and computer servers. The purpose of any system of protection is to reduce (if not eliminate) any residual current that may surge in ordinary systems in the structure. Because of the law on energy distribution, even if a lightning protection system is installed, once any given system is hit by a static discharge, the current will proportionally distribute itself inversely proportional to the different value of resistance in the path to ground.

If three electrical paths exist (A, B, and C) to ground, energy will be moving down to ground based on the effective resistance/conductance of each of these three lines. Lightning strike current can peak around 100,000 or more Amperes and even if the protection system has a very weak resistance (99.99% more conductive than the existing system), a fraction of 0.01% of the energy will still travel to ground via the existing systems and not the added protection system. If the conductance of protection system A is 99.89, and the effective conductance of B is 0.10, and C is 0.01, a fraction of the 100,000 Amp will flow down (B=100 Amp, C=10 Amp). If a badly done crimp reduces the conductance of the protection system A to 99.50 by creating one or multiple weak points for the current flow, three times more energy will flow down into the normal systems B, and C. Minor crimping issues may result in important problems. Protection systems require high conductance and crimping must be made in a way to limit any resistance in the connection.

Finally, large cables having great conductance in these protection systems are heavy, difficult to handle, install and service. Also, large cables cannot be cut easily or crimped easily. As part of FIG. 2, only small cables can be crimped. One of the desire in the field of protection systems is the capacity for any person to manage easily heavy copper and metal conductors locally at the point of installation. Also, what is needed is the capacity of a person to dispose of simple tools able to handle the largest possible sized cables where crimps are done in a way which optimize the conductance pathway.

Several key standards are used to help users manage crimping, for example UL 486 is for a single-polarity connector for use with all alloys of copper or aluminum, or copper-clad aluminum conductors for providing sufficient contact between current-carrying parts in accordance with the NFPA 70 in the USA, or NOM-001-SEDE in Mexico. For example, UL 486 generally to 4 AWG or larger conductors. All known standards are hereby incorporated by reference to this disclosure.

What is needed is a better, more optimized hand tool or tool designed with improved performances in relationship with crimping and/or cutting of conductors. Optimized performances include a greater range of conductor sizes to be handled, a lighter tool, a more portable and compact tool, a tool capable of being repaired or fixed with wear to name a few.

### SUMMARY

The present disclosure relates to a new improved dual crimping and cutting tool, such as a portable hand tool with removable for repair or adding features having a rotating jaw serving in one area as a cutter blade against the body of the tool, and in an adjacent area a crimping portion for conducting a semi-circular crimping for one of multiple size conductors. The invention includes features such as a multi-die removable wheel, a rounded periphery multi-die removable wheel, a dual segment jaw, a multiple angle crimping nest, a new jaw with a self-release and a manual release, a high leveraged multi-groove driving pawl, and a removable blade system.

### DRAWINGS

The drawings described herein are for illustrative purposes only of selected embodiments and not all possible implementations, and are not intended to limit the scope of the present disclosure.

FIG. 1 is a first set of illustration described in U.S. Pat. No. 2,795,769 from the prior art.

FIG. 2 is a crimper hand tool described in U.S. Pat. No. 5,138,865 from the prior art.

FIG. 3 is a side view of the conductive and mechanical dual crimper and cutter hand tool 100 without a top cover according to an embodiment of the present disclosure.

FIG. 4 is a detailed plan view of the thumb release 4 for use in the hand tool 100 as shown at FIG. 3 according to one embodiment of the present disclosure.

FIG. 5 is an isometric view of the removable blade main handle 1 for use in the hand tool 100 as shown at FIG. 3 according to one embodiment of the present disclosure.

FIG. 6 is a detailed plan view of the removable blade 3 for use in the hand tool 100 as shown at FIG. 3 according to one embodiment of the present disclosure.

FIG. 7 is a detailed plan view of the selector wheel 8 for use in the hand tool 100 as shown at FIG. 3 according to one embodiment of the present disclosure.

FIG. 8 is a detailed plan view of the removable blade jaw and compressor 2 for use in the hand tool 100 as shown at FIG. 3 according to one embodiment of the present disclosure.

FIG. 9 is a detailed plan view of a driving pawl 5 of the hand tool 100 as shown at FIG. 3 according to one embodiment of the present disclosure.

FIG. 10 is a detailed plan view of the tie rod 6 of the hand tool 100 as shown at FIG. 3 according to one embodiment of the present disclosure.

FIG. 11 is a detailed plan view of the lower handle 7 of the hand tool 100 as shown at FIG. 3 according to one embodiment of the present disclosure.

FIG. 12 is an illustration of the selector wheel 8 as shown at FIG. 7 with illustration of the different cradles and the conductors for use in the cradles of the eight positions of the selector wheel 8 according to one embodiment of the present disclosure.

FIG. 13 is an illustration of the selector wheel 8 of FIGS. 7 and 12 illustrating how the removable blade jaw 2 interacts with this wheel 8 according to one embodiment of the present disclosure.

FIG. 14 is a force diagram of the different forces acting upon a conductor/lug being crimped between the selector wheel 8 and the removable blade jaw 2 according to one embodiment of the present disclosure.

FIG. 15, the covered hand tool 100 as shown at FIG. 3 where the removable blade jaw 2 is part of the removable blade handle 1 in another embodiment of the present disclosure.

FIG. 16 force diagram over the hand tool 100 shown at FIG. 15 displaying the nutcracker effect according to one embodiment of the present disclosure.

FIG. 17 is a force diagram of the internal dynamics linked with several components resulting in a crimping force according to one embodiment of the present disclosure.

FIG. 18 a diagram showing a method for crimping a conductor using a dual crimping/cutting tool.

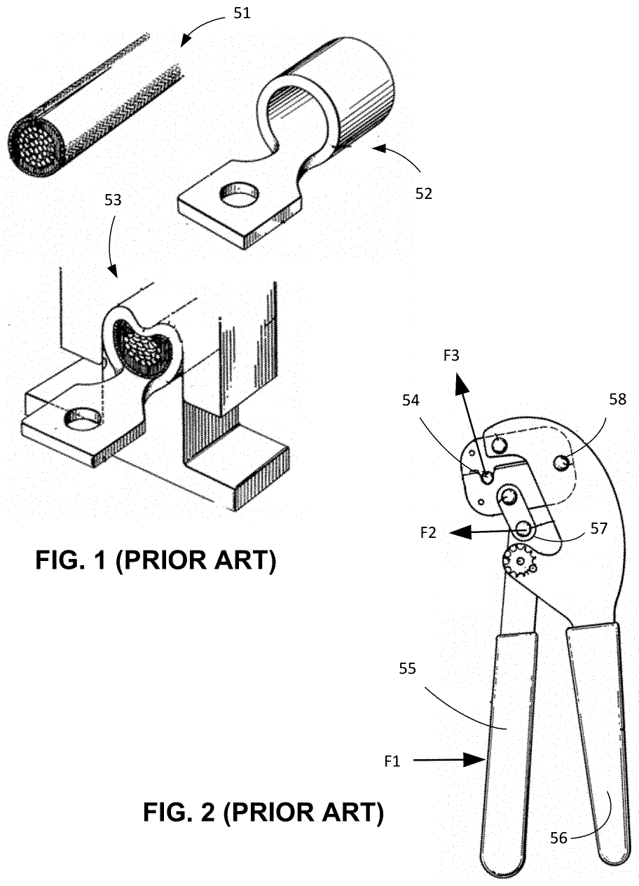

Corresponding reference numerals indicate corresponding parts throughout the several views of the drawings.

### DETAILED DESCRIPTION

### General Lexicology

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

### General Description of Invention

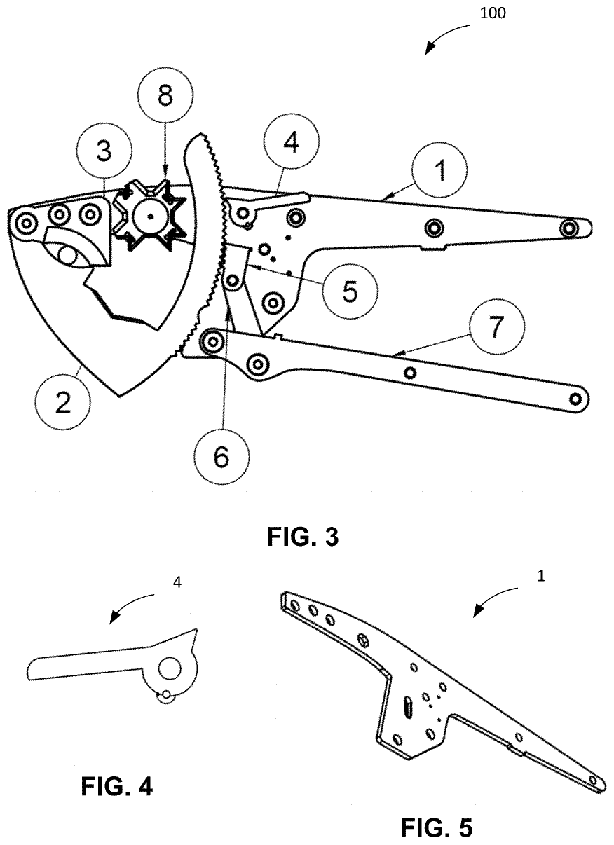

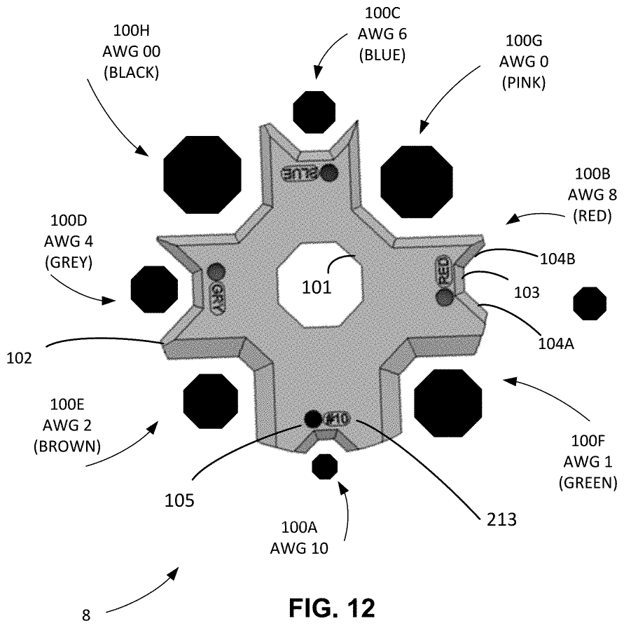

Before detailing the specifics of the new hand tool 100 generally shown at FIG. 3, the inventor focuses on several key elements, which alone or in combination are novel and non-obvious to one of ordinary skill in the art and worthy of protection. FIG. 3 includes element 8 which is a die/wheel 8 which can be rotated and/or removed from the tool 100. Before explaining each of the pieces (1 to 8) forming the tool 100, we direct the reader to FIGS. 12-14 which are different illustrations of the die wheel 8 aka a crimping wheel 8 in this disclosure.

Turning to FIGS. 12-14, the wheel 8 is generally used for the selection of one of multiple sized conductors. As shown at FIG. 12, the wheel 8 has a central opening 101, illustrated as octagonal (i.e. having eight peripheral sides) for one type of mounting on a hand tool. For example, by using an octagonal center axis, a tab used as resistance may allow for the easy selection and change from one position to the next.

The first major feature of the selector wheel 8 is how on the outside periphery 102, a segment is made to accommodate and crimp a series of eight different conductor sizes, each next to one of the eight sides of the central opening 101. In one embodiment, the selector wheel is mounted on a central pivot with tab (not illustrated) which allows for the simple manual rotation and lock into one of the eight peripheral position. As illustrated, along the external periphery of the selector wheel 8 are eight external V-shapes 100A to 100H. The openings 100A to 100D are for four smaller sized conductors (size AWG 10, 8, 6, and 4) and openings 100E to 100H are for larger sized conductors. (size AWG 2, 1, 0, and 00).

Each opening (100A to 100H) is positioned to create a conductor-sized cradle in U-shape having a flat bottom surface 103 flanked with two angled sides raised 104A, 104B as shown for AWG 8 1006. As a conductor to be crimped and its lug are deformed by the pushing force described below, the combine unit will tend to move laterally and connect to the side angles help maintain the rounded shape of the connector and its lug after crimping has been completed.

As shown at FIG. 12, these cradles are created in this U-shape or semi-octagonal shape. The angle of aperture is about 45 degree from the base creating walls that extrude outwardly. While one of ordinary skill in the art will observe this U-shaped cups/nests being created, that individual will understand that while this one model of topology is used, any number of topologies can be substituted in, such as a half circle, a larger base cup, or any other useful variation. Also, depending on the type of lug being crimped, a different configuration may be optimized. Also shown are markings such as colors or AWG numbering 105 to help the user of the wheel rotate the wheel 8 around the central opening 101.

In the embodiment as shown at FIG. 12, in addition to the four small caliber conductor openings (AWG 10 to 4), the positions located between two of these four positions also is designed as a U-shaped cup/nest for larger sized conductors (AWG 2, 1, 0, and 00). As shown, all eight of the crimping sizes are illustrated and can be used. Only four of the eight cradles include markings simply because of the current embodiment as shown below which is hidden under a metal portion. One simple variation is to create an opening in the metal to allow for better marking of all eight U-shaped cups/nests. Illustrated only for convenience are octagonal-shaped but one of ordinary skill in the art will understand this shape as illustrated is only suggestive and that since crimping is associated with plastic deformation of metal, many shapes can be used and processed. Generally speaking, the shape of the U-shaped cups/nests are designed to simplify tooling of the wheel 100 and to optimize both the mechanical strength of the crimped portion and the resulting conductive bond.

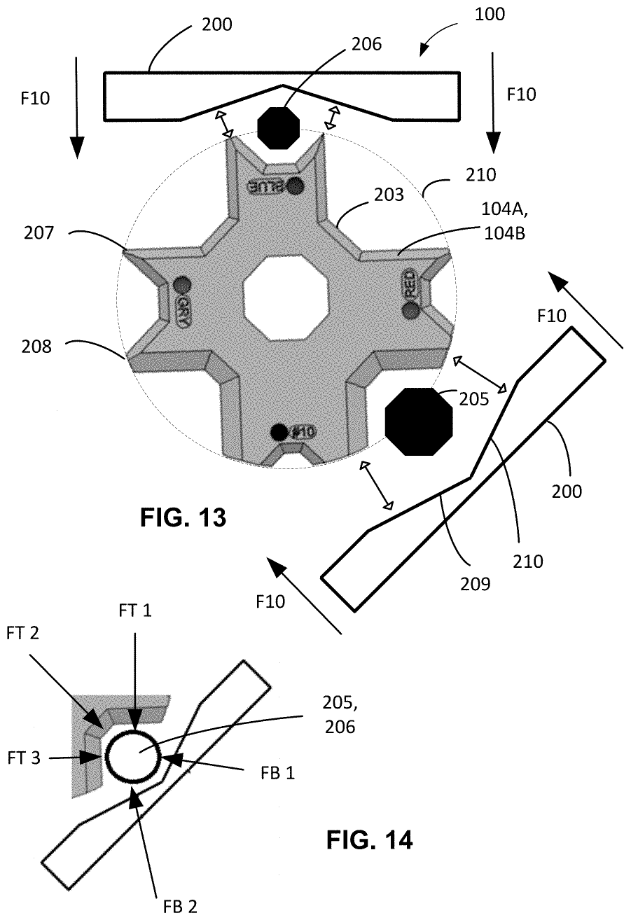

FIG. 13 shows several of the key properties of the wheel 8 during the crimping process. For crimping to occur in one of the U-shaped cups/nests, after one selected connector is slid in, a jaw 2 shown in full at FIG. 8 (a portion is illustrated as 200) can be made mechanically to move closer against the conductor 205 to squeeze and crimp. At FIG. 13, two potential positions are illustrated around the wheel 8 but in fact, in the tool 100 the wheel 8 is turned and not the jaw 2. While this configuration is shown, one of ordinary skill in the art will understand the other relationship is also contemplated in different embodiments of the tool.

As shown at FIG. 13, in both cases pressure via the push bar 200 shown as F10 acts against the conductor using a force F10. When crimping occurs, the first side of the conductor rests against the flat bottom surface 103 as shown, for the force F1 of a push bar 200 can come to squeeze the conductor illustrated as 205, 206 into the selected U-shaped cup/nest.

The outer periphery of the wheel 8 has been cut to respect a circular configuration 210 at a fixed radius from the center and having a thickness to avoid damage and allow the push bar 200 to come in contact with both sides without damaging the tips 207, 208 with a simple distance limiter (e.g. the squeezed distance is limited to the radius 210). To further limit damages, an angle of tips 207, 208 is designed to pair with an angle given locally in the bar 200. This angle is created by its own V-shaped 209, 211, and as shown with two side bars and no flat bottom part. Geometrically, each point of the external periphery tips 207, 208 is perpendicular to the radius of the wheel 8.

The embodiment shown is illustrative of one possible configuration. For example, a tool for larger conductors may have a wheel 8 with only six V-shaped nests. As illustrated at FIG. 14, once one size of conductor is selected, the push/force bar will create at least two forces FB1, FB2, which will push against the tool by two or three counterbalancing forces FT1, FT2, and FT3. The goal is to generate a semi-circular force configuration around the conductor and once the bar 200 connects with the tips 207, 208 on each side of the cup/nest, it will optimize the compression forces and generate a relatively circular crimp instead of a flat crimp. One of ordinary skill in the art will recognize that while a V-shape is used a different effective structure may be contemplated. Also shown is a set of angled softening angles of 104A and 104B as illustrated which softened by an angle cut locally to focus the strength of the force FT1, 2, 3 to a smaller portion of the width. As shown, each nest is often a 90 degree V-shaped with a flat bottom creating a U-shape.

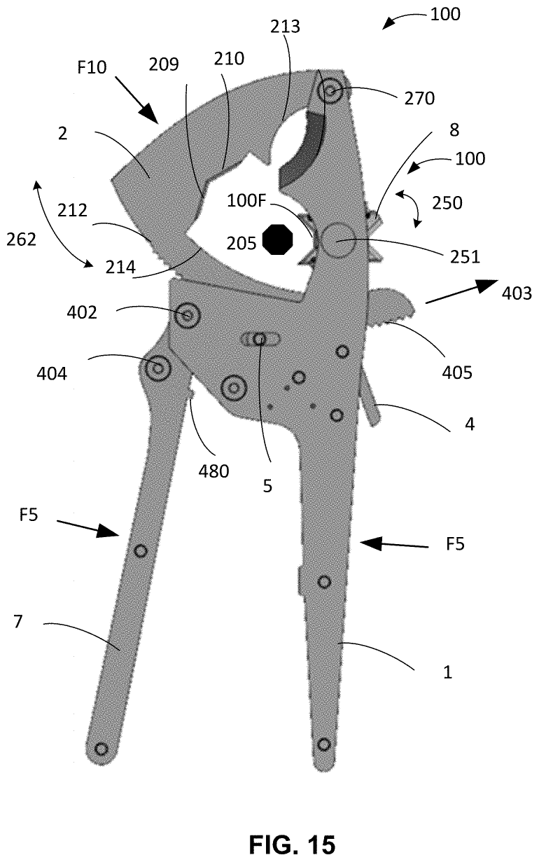

The wheel 8 is shown in one possible installation at FIG. 3 and with greater detail at FIG. 15 in operation. Moving to FIG. 15, the wheel 8 is mounted to the tool 100. Again, while one configuration is shown, more is contemplated. The wheel 8 is mounted with a dial 251 that can be rotated 250 to select the proper U-shaped cup/nest, as shown 100F for receiving a connector 205 of the specified type.

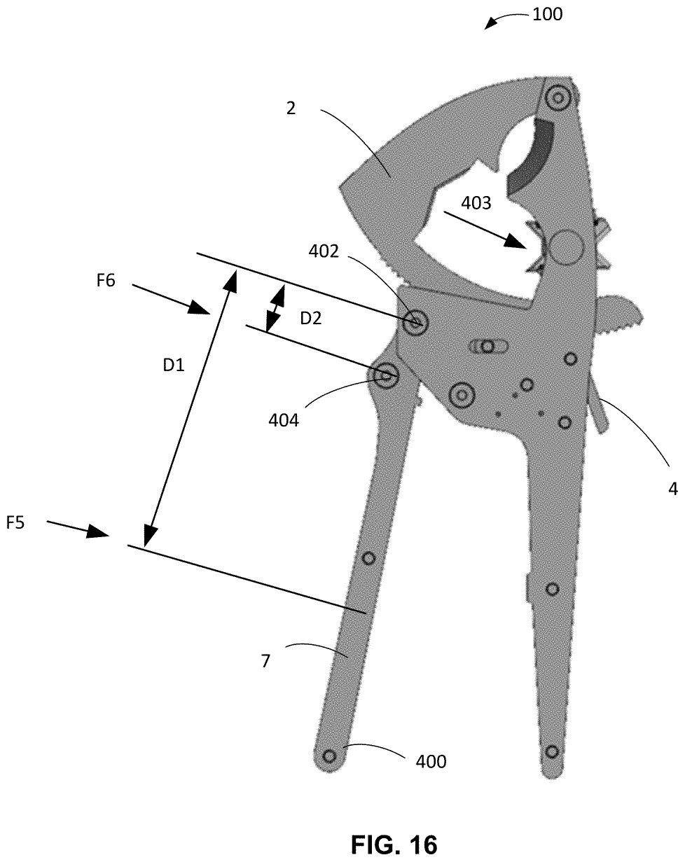

The bar 200 can be part of the jaw aka a compressor 2 as described below. On the inside portion of the jaw 2 is designed to be cranked slowly into position around pivot 270. Generally speaking, the lips 209, 210 will slowly come to crush the conductor 205 against the nest illustrated as 100F in a movement 262 created by a slow pivot of the jaw 2 around the pivot point 270. The movement of the handles 1 and 7 of the tool 100 create as described after this force and movement. A specific diagram of the forces on tool 100 is shown at FIG. 16. By placing the hand grip force F5 on both handles 1 and 7 of the tool 100 and making a movement at the pivot 402, a slow high-power movement is created in direction 403 in the jaw 2 as it is attached at pivot 270. As illustrated multiple “cranks” are needed here each for a single short distance at high-power. The distance moved can be shown by the small notches 405 on the lower portion of the jaw 2. Release tab 4 is shown which is designed to disconnect and is described below.

The crimping portion of tool 100, as described is built to increase the size of conductors 205 (and its lug/second conductor) which can be crimped manually with a hand tool 100. A design is created which allows for greater effective compression forces F10 to be applied as described above. The average 30 year old man has a gripping force of about 40.25 kg of pressure on a dynamometer. This force can fall by half for the other gender, or for a person not using a dominant hand. This tool had to operate with a force of only F5=20 kg. As shown, the tool 100 is large enough for two hands to be employed but for the purpose of this disclosure, numbers are offered for one hand use.

FIG. 16 explains how a force F5 is multiplied at the point 404 using the “nutcracker” effect, where by pivoting around 402, the ratio of D1/D2=F6/F5, as shown D1 is approximately 5-8 times D2 so the increased grip force F6 will be 5-8 times F5. For a compression force of about 20 kg, the resulting crimping vector is approximately F6=100 to 160 kg. The downside to using this effect is that net lateral movement at 404 is also reduced proportionally. While the tip of the hand 400 may move 2 inches, the pivot 404 will move at most a fraction of an inch. The inventor has created a cumulative effect where by using a plurality of cranks, the jaw 2 serving as a compressor 200 will be made to connect to the conductor.

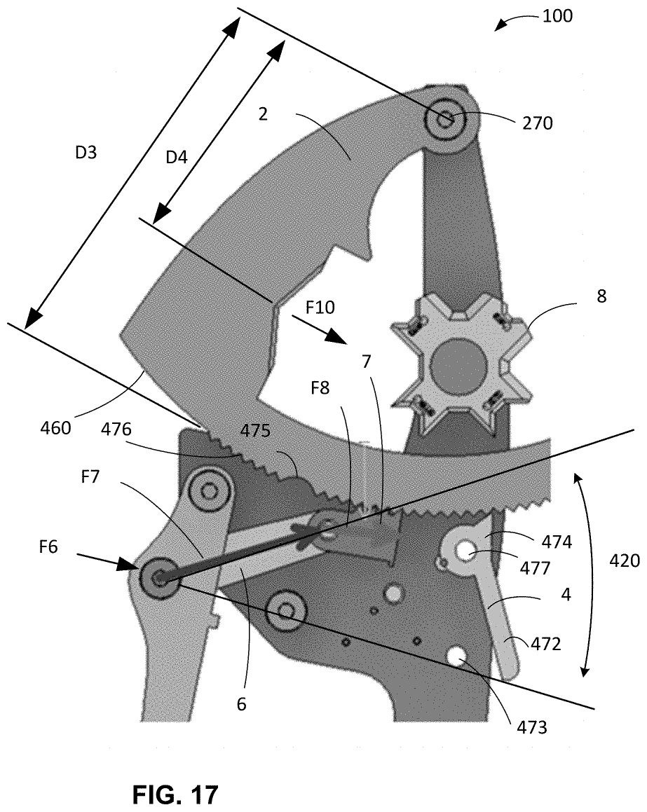

At FIG. 17, the internal mechanism of the tool 100 is shown where F8 is generated is shown in greater detail. The increased grip force F6 is then transferred via a tie rod 6 to a driving pawl 7. As shown, angle 420 is applied which reduces the force (F7=F6 cos Θ) and the same angle 420 is then added to return the force F10 perpendicular to the edge 460 of the jaw 2 (F8=(F6 cos Θ)²). For an angle of Θ=30 degrees, F7=87% of F6 and F10=75% of F6. In the embodiment as shown, F10 is in the area of 75 to 120 kg (165 to 265 lb of force). As illustrated, driving pawl 7 is attached to the outside plates of the tool 100 using a slider-type lock and moves as illustrated. In one embodiment as shown, four teeth engage the teeth 476 of the jaw 2.

This allows for part of the force F8 to be distributed in more teeth which is often needed when the compression is at the mid-range in the crimping. This results in F8/3 on each tooth. One of ordinary skill in the art will understand that force must be increased until plastic deformation begins locally, as this begins, more portion of the object to be crimped touches the external walls which decreases the force locally on the tool, spreads the force internally in the tool and in the conductor but also allows for the strain distribution to be better distributed locally. Also shown, using a second “nutcracker” effect, by rotation around pivot point 270, the external force F8 is then increased to become the effective compressive force F10 by the ratio or D3/D4 or about 1.4 to 1.6 depending on configurations. This corrects the loss in power linked with the pawl 7 and results in F6 being almost equal to F10.

While the above describes generally the method of operation in which a greater force F10 can be leveraged in a single hand tool for a normal grip F5, one of ordinary skill in the art will understand a wide range of technology can be used to further leverage these effects. For example, in some tools a turn knob/screw system allows for the slow movement of an axe up a shaft which creates higher local forces. The jaw 2 as shown must be released, to do so, the pawl 7 is lowered and the crank designed to hold the jaw 2 against the aperture (i.e. a clockwise movement around 270) is release latch/thumb release 4. This latch 4 has a push tab 472 for manual activation, it rotates the piece down (at most to tab 473) around point 477 which lifts lip 474 releasing the jaw 2 which is then free to move back out clockwise around pivot 270. Once again, while one mode of release is shown, the tool can be made with any mode known in the art. A

Returning to FIG. 15, since multiple short cranks must be done to slowly move the jaw 2 against the conductor 205, and as described above because each applied force F5 results in a small lateral movement of the jaw 2 around the pivot 270. Element 480 shows a spring connected internally and pushed against a tab as illustrated to keep the handle 7 off and in a return position once pressure F5 ends. This will play mildly against F6 and help quick action. Other types of biasing elements can be used and are not limited to the current vision.

At FIG. 17, also shown on jaw 2 is an opening 475 in the series of teeth used by the pawl 7 to move the jaw 2 against the conductor when present 205. This opening is one way to protect the jaw 2 and the wheel 8 from over-pivoting around 270 in a way which would place some or all of the force F10 upon the teeth of the wheel 8. Not only is the wheel 8 cut to a round configuration 210 to avoid contact with the jaw 2, but the opening 475 is designed to prevent the arm from pushing past a certain point. By using the opening, as this zone gets closer, the force F8 is then distributed on three, then two, and finally one tooth only giving the user an increased resistance at the end of the crimp. To summarize, F10 will be transferred to one tooth only at the end of the crimp creating an increased field of resistance. While this system is shown, one of ordinary skill in the art will recognize that many different systems can be built to limit the course of action of the jaw 2 including the use of a biasing element, a tab, a limiter, etc. For example, the pivot point 270 can be adapted to move only past a certain limit.

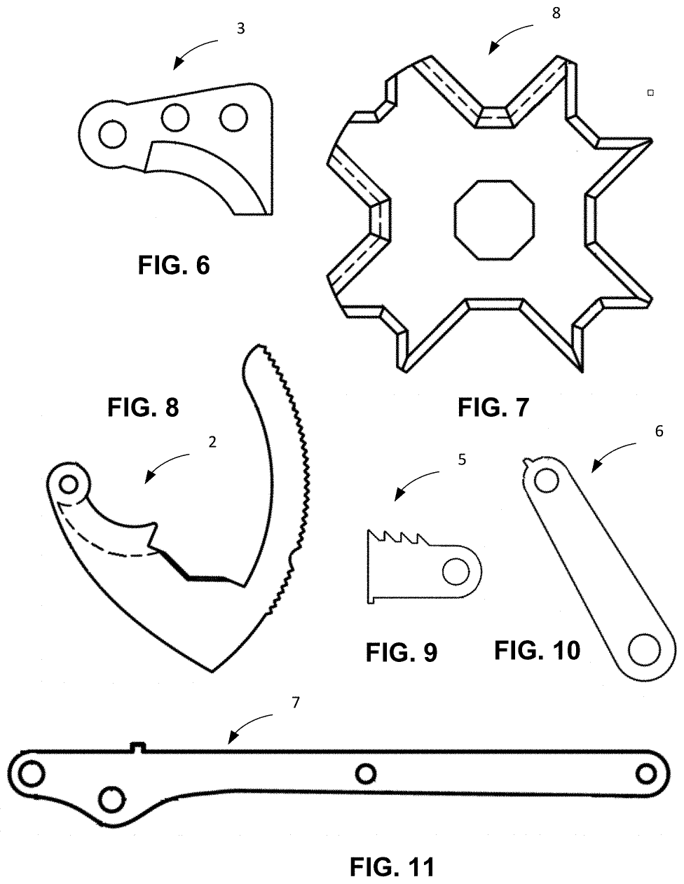

To further help the understanding of the invention, what is shown are FIGS. 4-12 which FIG. 4 is a detailed plan view of the thumb release 4 for use in the hand tool 100 as shown at FIG. 3 according to one embodiment of the present disclosure. FIG. 5 is an isometric view of the removable blade main handle 1 for use in the hand tool 100 as shown at FIG. 3 according to one embodiment of the present disclosure. FIG. 6 is a detailed plan view of the removable blade 3 for use in the hand tool 100 as shown at FIG. 3 according to one embodiment of the present disclosure. FIG. 7 is a detailed plan view of the selector wheel 8 for use in the hand tool 100 as shown at FIG. 3 according to one embodiment of the present disclosure. FIG. 8 is a detailed plan view of the removable blade jaw and compressor 2 for use in the hand tool 100 as shown at FIG. 3 according to one embodiment of the present disclosure. FIG. 9 is a detailed plan view of a driving pawl 5 of the hand tool 100 as shown at FIG. 3 according to one embodiment of the present disclosure. FIG. 10 is a detailed plan view of the tie rod 6 of the hand tool 100 as shown at FIG. 3 according to one embodiment of the present disclosure. FIG. 11 is a detailed plan view of the lower handle 7 of the hand tool 100 as shown at FIG. 3 according to one embodiment of the present disclosure. FIG. 12 is an illustration of the selector wheel 8 as shown at FIG. 7 with illustration of the different cradles and the conductors for use in the cradles of the eight positions of the selector wheel 8 according to one embodiment of the present disclosure. These pieces, when assembled as shown at FIG. 3 recreate one embodiment of the tool 100.

The inventor has invented, for example, a crimping wheel 8 as shown for a crimping tool 100, the wheel 8 being made of metal and having a general thickness, in the range of 2-10 mm and an outer periphery 210 as shown at FIG. 13 along an external circular radius. The wheel 8 also including at least a plurality of U-shaped nests 100A to 100H as shown at FIG. 12 with greater detail carved in the external circular radius 210 each sized for a connector size as illustrated for receiving and crimping a connector as illustrated 205 and a lug (not shown) placed and forced against a set of walls of one of the U-shaped nest as illustrated at FIG. 14. The U-shaped nests 100A to 100H (or any equivalent number) can be carved in the external circular radius have three flat walls 103, 104A, and 104B as illustrated at FIG. 12. including a base wall 103 flanked by two side walls 104A, 104B as the set of walls. In some embodiments as shown, the base wall 103 is tangential to the radius of the crimping wheel and both side walls 104A, 1046 are identical in orientation from the base wall 103. Once again, the wheel 8 as shown allows for a great range of conductor to be handled by a single tool. The fact that the wheel 8 is removable allows for some wear and tear and replacement in case damage occurs. wherein between each side of the plurality of U-shaped nests are sides has a tip portion rounded along the circular outer periphery and wherein each of the tip portion of each of the plurality of nests is at a similar radial distance from the center of the crimping wheel

In addition to simply having a novel wheel 8, the tool 100 has a unique jaw 2 and functions which are also claimed. The a jaw 2 shown in combination with the tool in FIG. 3 and alone at FIG. 8 for a crimping and cutting hand tool 100. The jaw having a thickness function of the tool's effective size but in one embodiment about ¼ of an inch in size and comprising a curved L-shaped body as shown at FIG. 8 in the thickness with a pivot connector 270 as shown at FIG. 15 on one end of the L-shaped body for rotation around the pivot connector 270, an external pulling edge portion 212 on the outer side of the L-shaped body, and at least a crimping portion 209, 210 and a cutting portion 213 on an internal edge 214 portion of the L-shaped body.

As shown at FIGS. 13-15, the crimping portion comprises a V-shaped portion with two substantially flat walls 209, 210 for creating a multi-point crimp as best shown at FIG. 14. Also as shown at FIG. 17, the external pulling edge portion 212 includes a set of teeth 212 for interlock with an external force element 7 over the entire portion except for an offset segment 475 placed between two teeth portions as shown for creating a maximum angular position for an automatic release of the jaw 2. The external pulling edge portion 212 is on only one of the two sides of the L-shaped body as shown being on the lower side.

Also claimed and described is a hand tool 100 for crimping and cutting a conductor 205, the hand tool 100 comprising a body as shown at FIG. 3 a jaw 2 connected pivotally to the body via a pivot 270 comprising an external pulling edge 212 and an internal edge 214 comprising at least a cutting portion 213 and a crimping portion 209, 210, a first handle 1 connected or part of the body, a second handle 7 pivotally connected to the body 404 for creating a force upon the external pulling edge 212 by relative movement of the second handle 7 around the pivot 404 as shown at FIG. 16, a cutter 3 connected or part of the body 213 for cutting a connector 205 when the jaw 2 is pivoted by the force applied upon the external pulling edge 212 as the connector 205 is compressed between the cutter 3 and the cutting portion 213 and a crimping wheel 8 with a plurality of V-shaped nests 100 each for a different connector size connected to the body for crimping the connector 205 and a lug when the jaw 2 is pivoted by the force applied upon the external pulling edge 212 for mating the crimping portion 209, 210 and the crimping wheel 8 to a first of the nests 100.

The crimping wheel 8 includes eight nests 100A to 100H, each for a different sized conductor 205. The crimping portion includes a V-shaped portion 209, 210 as shown at FIGS. 13-14 includes the nests are U-shaped, and wherein the connector and lug is surrounded by five surfaces during crimping FT1., FT2, FT3, FB1, and FB2T. The force upon the external pulling edge as shown at FIG. 17 is generated between the second handle 7 and the external pulling edge 476 by a tie rod 6 pivotally connected to the second handle 7 and a driving pawl 7 pivotally connected to the tie rod 6 and slidably connected to the body and wherein the external pulling edge 476 includes teeth interlocked with at least a tab on the driving pawl as shown at FIG. 9.

The tool further comprises a thumb release 4 with a pusher 472 and a blocking tab 474 pivotally connected to the body and wherein the blocking tab 474 is in contact with the external pulling edge 476 for preventing clockwise pivot of the arm 2 around its pivot point 477 with the body. By pushing the pusher 472 of the thumb release 4, the thumb release 4 pivots around the pivotal connection 477 to distant the blocking tab 474 from the external pulling edge to allow clockwise pivot of the arm 2 around its pivot point 270 with the body. The tool 100 further comprises a thumb release 4 with a blocking tab 474 pivotally connected to the body 477 and wherein the external pulling edge includes an offset 475 at a maximum angular position to automatically release the clockwise rotation of the arm once the blocking tab 474 is placed promixal to the offset.

The cutter 3 as shown at FIG. 6 for example is integral and non-removable from the body as shown at FIG. 16. In another case shown at FIG. 3, it can be removed. In FIG. 17, the cutter is absent. Also, as shown at FIG. 16, the first handle 1 is integral and non-removable from the body. Returning to FIG. 13, each of the plurality of nests 100A to 100H is U-shaped having a bottom surface 203 and two side surfaces 104A, 104B sized to receive the conductor 205 to be crimped in the nest and wherein each of the two sides has a tip portion 207, 208 and where each of the tip portion 207, 208 of each of the plurality of nests 100A to 100H is at a similar radial distance from the center of the crimping wheel as illustrated by line 210.

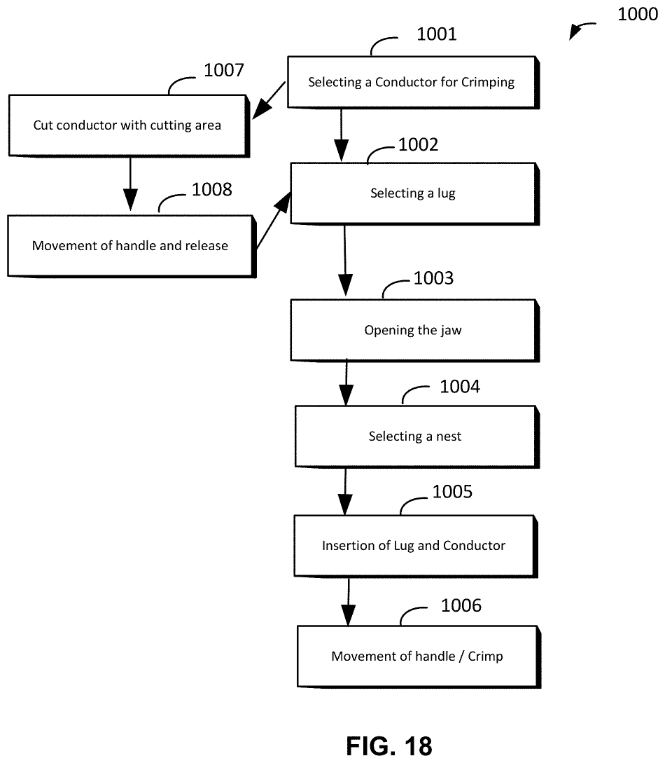

Finally, FIG. 18 shows one method 1000 of mechanically and conductively crimping a conductor 205 using a hand tool as described above or a hand tool which has some or many of the above features. The method relates to steps of selecting 1001 a conductor for crimping, then selecting 1002 a lug sized for the conductor for crimping in 1001. As explained while the term “lug” is used, what is contemplated is any pairing deformable element which can be bent into a crimp alongside the conductor including another conductor (wrapped or not) or even a composite set of conductive wire bundled into one.

The method 1000 then includes the step of opening 1003 the jaw of the tool by clockwise pivot of the jaw around the pivot, selecting 1004 one of the plurality of nests in the crimping wheel adapted for crimping of the conductor and the lug selected, inserting 1005 between the selected nest and the V-shaped portion of the jaw the conductor and the lug, and moving 1006 the first handle by relative movement of the second handle around the pivot to create a force upon the external pulling edge rotating counter-clockwise the jaw and repeating the movement of the previous step of the second handle until the V-shaped portion touches the crimping wheel.

Also shown at FIG. 18, the previous two steps 1001 to 1006 include the creation of a five point crimping force upon the conductor and the lug wherein two of the five points are on the V-shaped portion and three of the five points are inside the nest selected on the wheel. Also, as described and shown, the tool 100 further includes a cutting section and wherein subsequent to the step of selection 1001 of the conductor but precedent to the step of selection 1002 of the lug, the method further includes the steps of cutting 1007 the conductor by moving 1008 the first handle by relative movement of the second handle around the pivot to create a force upon the external pulling edge rotating counter-clockwise the jaw and repeating the movement of the previous step of the second handle until the conductor is cut and releasing the jaw for clockwise rotation to release the conductor.

What is claimed is:

1. A hand tool for crimping and cutting a conductor, the hand tool comprising:
a body;
a jaw connected pivotally to the body via a pivot comprising an external pulling edge and an internal edge comprising at least a cutting portion and a crimping portion;
a first handle connected or part of the body;
a second handle pivotally connected to the body for creating a force upon the external pulling edge by relative movement of the second handle around the pivot;
a cutter connected or part of the body for cutting a connector when the jaw is pivoted by the force applied upon the external pulling edge as the connector is compressed between the cutter and the cutting portion; and
a crimping wheel with a plurality of nests each for a different connector size connected to the body for crimping the connector and a lug when the jaw is pivoted by the force applied upon the external pulling edge for mating the crimping portion and the crimping wheel a first of the nests.

2. The hand tool of claim 1, wherein the crimping wheel includes eight nests, each for a different sized conductor.

3. The hand tool of claim 1, wherein the crimping portion includes a V-shaped portion, the nests are U-shaped, and wherein the connector and lug is surrounded by five surfaces during crimping.

4. The hand tool of claim 1, wherein the force upon the external pulling edge is generated between the second handle and the external pulling edge by a tie rod pivotally connected to the second handle and a driving pawl pivotally connected to the tie rod and slidably connected to the body and wherein the external pulling edge includes teeth interlocked with at least a tab on the driving pawl.

5. The hand tool of claim 1, where the tool further comprises a thumb release with a pusher and a blocking tab pivotally connected to the body and wherein the blocking tab is in contact with the external pulling edge for preventing clockwise pivot of the arm around its pivot point with the body.

6. The hand tool of claim 5, wherein by pushing the pusher of the thumb release, the thumb release pivots around the pivotal connection to distant the blocking tab from the external pulling edge to allow clockwise pivot of the arm around its pivot point with the body.

7. The hand tool of claim 1, wherein the tool further comprises a thumb release with a blocking tab pivotally connected to the body and wherein the external pulling edge includes an offset at a maximum angular position to automatically release the clockwise rotation of the arm once the blocking tab is placed promixal to the offset.

8. The hand tool of claim 1, wherein the cutter is integral and non-removable from the body.

9. The hand tool of claim 1, wherein the first handle is integral and non-removable from the body.

10. The hand tool of claim 1, wherein each of the plurality of nests is U-shaped having a bottom surface and two side surfaces sized to receive the conductor to be crimped in the nest and wherein each of the two sides has a tip portion.

11. Then hand tool of claim 1, wherein each of the tip portion of each of the plurality of nests is at a similar radial distance from the center of the crimping wheel.

12. A crimping wheel for a crimping tool, the wheel being made of metal and having a general thickness and an outer periphery along an external circular radius, the wheel also including at least a plurality of U-shaped nests carved in the external circular radius each sized for a connector size for receiving and crimping a connector and a lug placed and forced against a set of walls of one of the U-shaped nest.

13. The crimping wheel of claim 12, wherein the U-shaped nests carved in the external circular radius have three flat walls including a base wall flanked by two side walls as the set of walls.

14. The crimping wheel of claim 13, wherein the base wall is tangential to the radius of the crimping wheel and both side walls are identical in orientation from the base wall.

15. The crimping wheel of claim 12, wherein between each side of the plurality of U-shaped nests are sides has a tip portion rounded along the circular outer periphery and wherein each of the tip portion of each of the plurality of nests is at a similar radial distance from the center of the crimping wheel.

16. A jaw fora crimping and cutting hand tool, the jaw having a thickness and comprising a curved L-shaped body in the thickness with a pivot connector on one end of the L-shaped body for rotation around the pivot connector, an external pulling edge portion on the outer side of the L-shaped body, and at least a crimping portion and a cutting portion on an internal edge portion of the L-shaped body.

17. The jaw of claim 16, wherein the crimping portion comprises a V-shaped portion with two substantially flat walls for creating a multi-point crimp.

18. The jaw of claim 16, wherein the external pulling edge portion includes a set of teeth for interlock with an external force element over the entire portion except for an offset segment placed between two teeth portions for creating a maximum angular position for an automatic release of the jaw.

19. The jaw of claim 16, wherein the external pulling edge portion is on only one of the two sides of the L-shaped body.

20. A method of mechanically and conductively crimping a conductor using a hand tool comprising a body, a jaw connected via a pivot pivotally to the body comprising an external pulling edge and an internal edge comprising at least a crimping portion and wherein the crimping portion includes a V-shaped portion, the tool including a first handle connected or part of the body, a second handle pivotally connected to the body, and a crimping wheel with a plurality of nests, the method comprising the steps of:
selecting a conductor for crimping;
selecting a lug sized for the conductor for crimping;
opening the jaw by clockwise pivot of the jaw around the pivot;
selecting one of the plurality of nests in the crimping wheel adapted for crimping of the conductor and the lug selected;
inserting between the selected nest and the V-shaped portion of the jaw the conductor and the lug; and
moving the first handle by relative movement of the second handle around the pivot to create a force upon the external pulling edge rotating counter-clockwise the jaw;
repeating the movement of the previous step of the second handle until the V-shaped portion touches the crimping wheel.

21. The method of claim 21, wherein the previous two steps include the creation of a five point crimping force upon the conductor and the lug wherein two of the five points are on the V-shaped portion and three of the five points are inside the nest selected on the wheel.

22. The method of claim 20, wherein the tool further includes a cutting section and wherein subsequent to the step of selection of the conductor but precedent to the step of selection of the lug, the method further includes the steps of:
cutting the conductor by moving the first handle by relative movement of the second handle around the pivot to create a force upon the external pulling edge rotating counter-clockwise the jaw;
repeating the movement of the previous step of the second handle until the conductor is cut; and
releasing the jaw for clockwise rotation to release the conductor.
